(19) United States
(12) Patent Application Publication
(10) Pub. No.: US 2002/0004738 A1
(43) Pub. Date: Jan. 10, 2002

(54) Distribution management system and distribution management method

(76) Inventors: Hiraku Izumino, Tokyo (JP); Takayuki Fushi, Tokyo (JP); Yasuiku Koike, Saitama-ken (JP)

Correspondence Address: LAW OFFICES OF TOWNSEND & BANTA, Suite 500, 1225 Eye Street, N.W., Washington, DC, 20005, US

(21) Appl. No.: 09/871,660

(22) Filed: Jun. 4, 2001

(30) Foreign Application Priority Data
May 2, 2000 (JP) PATENT2000-166046

(51) Int. Cl. G06F 17/60

(52) U.S. Cl. 705/10; 705/28

(57) ABSTRACT

The present invention relates to a distribution management system comprising: a plurality of material suppliers; a plurality of product processing factories for processing a product; a delivery center; and a control center for making a store order-estimation table so as to make an estimation regarding a quantity of a product to be ordered from a store and a quantity required to be produced by the respective product processing factories based on a prescribed information and deciding a quantity of the respective materials to be ordered to the material supplier based on the store order-estimation table and ordering the quantity to the material suppliers, and deciding a quantity of the respective materials to be supplied to the product processing factories and instructing the delivery center to deliver the materials to the respective product processing factories.

### BACKGROUND OF THE INVENTION

1. Field of the Invention

This invention relates to a distribution management system for providing material from a material supplier to a product processing factory; more particularly, a distribution management system enabling a distribution section to take initiative in ordering and supplying a suitable quantity of material without shortage.

2. Description of Related Art

Nowadays, products such as various lunches, sandwiches and coffee sold by widely spreading chain stores as convenience stores or the like are managed at a high level in means to maintain appearance and quality of the products. Therefore, not only are the variety and the quantity of food ingredient managed carefully, but also the appearance and quality of tableware such as trays, package material, knives and forks are managed carefully as well; a factory producing and processing the products would order various material from respective material suppliers designated by the headquarters of a convenience store serving as a product development managing body.

FIG. 5 shows a conventional example of a distribution system between material suppliers and product processing factories. The conventional example explains distribution of material by using a case where lunches of a convenience store are being produced.

In order for lunches and sandwiches to be produced, tableware such as trays, knives and forks; container related material such as plastic dividers; or food ingredient such as meat, rice, vegetables are required to be supplied from respective material suppliers 50 to product processing factories 53 at a suitable quantity and at a suitable timing.

Product order information [1] is provided in a data form to the respective product processing factories 53 directly from a retail store 54 or via the headquarter of a convenience store (not shown). Owing to a limit of time from production to consumption of foods such as lunches and sandwiches, the entire country is divided into prescribed areas and product processing factories are designated for each of the areas. Accordingly, plural product processing factories 53A . . . 53Z, and plural secondary delivery centers 52A . . . 52Z for supplying material to the product processing factories 53 are stationed at each area.

At the same time of producing prescribed lunches ordered from a group of the retail stores 54 and providing the lunches to the group of retail stores 54 (distribution route D14), each of the product processing factories 53 manages an inventory of the material and orders the material to be supplied from the material supplier 50 in preparation for the next order so as to prevent trouble in the production of the ordered products.

The materials are ordered to and supplied from various plural material suppliers 50A . . . 50Z depending on the kind of materials; for example, trays, seasoning packs and paper napkins are supplied from material supplier 50A, plastic tableware such as forks and knives are supplied from material supplier 50B and food ingredient such as rice and bread are supplied from material supplier 50C. Subsequently, the material supplier 50 having received the order delivers the material to a primary delivery center 51 in compliance with the respective supply order information I21, I22, I23 . . . I2n (distribution route D11).

The primary delivery center 51 confirms the product processing factory 53 (e.g. product processing factory 53B) designated as a destination for supply by the material supplier 50, and then designates a secondary delivery center 52B being in charge of the product processing factory 53B. Then, along with other material sent from other suppliers 50 bound for the product processing factory 53B, the primary delivery center 51 gathers and delivers the material to the designated secondary delivery center 52 (distribution route D12). Then, the secondary delivery center delivers the material sent from the primary delivery center 51 to the product processing factory 53, and then, the product processing factory stores the material as stock material(distribution route D13).

With the above conventional distribution management system, the information regarding the needs of the retail stores 54 were sent in a bottom-up manner causing a distribution section to act subordinately to the information. Further, due to a time lag of distribution, the ordering/supplying of products from/to the retail stores 54 and the ordering/supplying of material to/from the material supplier 50 were performed as separate processes, wherein the inventory of each product processing factory 53 and the transported inventory of the primary delivery center served as a buffering means. Accordingly, a problem where each of the product processing factories 53 had a transported stock or actual stock overly exceeding the quantity necessary for production, or a problem where a shortage is caused numerously from overestimating the stock was raised due to the effort in trying to prevent a lack of supply of products for the group of retail stores 54.

Further, since the ordering of material to the material suppliers 50 were independently performed by the respective product processing factories 53, and since product production and material management were performed separately at the level of the primary delivery center 51 and the secondary delivery center 52, an order error of a particular material or a time lag of distribution would cause a lack of stock of a particular material e.g. plastic fork resulting to an insufficient quantity of lunches to be produced or would cause an excessive quantity of stock of the particular material.

Therefore, it is an object of this invention to provide a distribution management system enabling a distribution section to unitarily manage the inconsistent information of the respective distribution routes for taking initiative in ordering material to the material supplier and initiative in supplying material to the product processing factory so that the process of production at the product processing factory and the process of supplying material from the material supplier could be connected and so that a suitable quantity of material could be ordered and supplied.

### SUMMARY OF THE INVENTION

This invention regarding a distribution management system serves to solve the foregoing problems by providing a distribution management system comprising: plural material suppliers; plural product processing factories for processing a product by using material provided from the material suppliers; a delivery center for combining and transporting plural various materials transported from the plural material suppliers with material of a quantity required by the product processing factories to the product processing factories; and a control center serving to make a store order-estimation table so as to make an estimation regarding a quantity of a product to be ordered from the store and a quantity required to be produced by the respective product processing factories based on a prescribed information, and serving to decide a quantity of the respective materials to be ordered to the material supplier based on the store order-estimation table and ordering the quantity to the material suppliers, and serving to decide a quantity of the respective materials to be supplied to the product processing factories and instructing the delivery center to deliver to the respective product processing factories.

In respect of this distribution management system, the control center existing between the material supplier and the product processing factory unitarily manages information and takes initiative in controlling distribution based on the store order-estimation data instead of having to act subordinately to the needs of the downstream side; accordingly, the control center could solely order material to the material supplier and supply to the product processing factory so that the entire distribution of material could be overseen and a sufficient quantity could be ordered and supplied.

The delivery center could be composed of a single or plural primary delivery center(s) for gathering each material from the material suppliers, and plural secondary delivery centers for receiving material sent from the primary delivery center(s) and further transporting the material to the product processing factories assigned to the secondary delivery center. The control center could serve as an independent body or could serve as both a control center as well as a primary delivery center.

Especially in a case where the primary delivery center also serves as a control center, since the primary delivery center actually managing distribution could manage information and distribution unitarily and since the primary delivery center could take initiative in supplying (pushing) in a downstream (respective product processing factory) direction and take initiative in ordering (pulling) in a upstream (respective material supplier) direction, the distribution management system of this invention could be performed more efficiently.

The primary delivery center could keep track online the reserve production inventory including the material already having been instructed to be produced and ordered for supply to the material supplier and the material already having been produced; and also keep track of the quantity of material inventory existing on the transportation route (transport inventory); accordingly, thus keeping track could be made into use for the information management of this invention so that inventory for the respective materials could be compressed and so that the supply for each product processing factory could be achieved without any shortage. The reserve production inventory refers to an uncompleted reserve inventory in a case where a production plan is already concluded along with a production inventory where production is already completed.

In a case where the primary delivery center also serves as a control center, the primary delivery center actually managing distribution could keep track of the time lag from between a time when each material is ordered to a time when the product processing factory orders an estimation to the delivery center. Accordingly, compared to the supply of the conventional distribution management system which depended upon the inventory existing on the distribution route, the inventory could be compressed to a minimal quantity for achieving distribution management more efficiently by considering the time lag as a leading time during the information management.

Further, this invention proposes a distribution management method comprising the steps of: making a store order-estimation table based on a prescribed information; making a demand estimation data for each respective material by converting product based data to material based data based on the store order-estimation table; making an order table categorized into each respective material supplier by considering and revising the demand estimation data for at least the inventory of the respective delivery centers; and ordering to each material supplier based on the order table. With such distribution management method, the product base data handled downstream of the distribution route and the material base data handled upstream of the distribution route could be unitarily managed and the ordering/supplying of material could be performed smoothly.

The revising of the demand estimation data could be performed with consideration of the transport inventory of each material existing on the distribution route. The ordering to each of the material suppliers could be performed with consideration of a lead time starting from a time when each material is ordered to the material supplier to a time when the product processing factory orders an estimation to the delivery center. Accordingly, by performing distribution management more precisely, the total inventory including the reserve production inventory already ordered to the material supplier and the reserve production inventory already produced at the material supplier could be minimized and a more efficient distribution could be achieved.

### BRIEF DESCRIPTION OF THE DRAWINGS

The above and other objects and features of the invention are apparent to those skilled in the art from the following preferred embodiments thereof when considered in conjunction with the accompanied drawings, in which:

FIG. 1 is a structural view showing a distribution management system regarding an embodiment of this invention;

FIG. 2 is an explanatory view of making a store order-estimation table;

FIG. 3 is an explanatory view of making a material order-estimation table by using a store order-estimation table;

FIG. 4 is a flow chart of a control center starting from an estimation a store order till an ordering of materials; and

FIG. 5 is a structural view showing a conventional distribution management system.

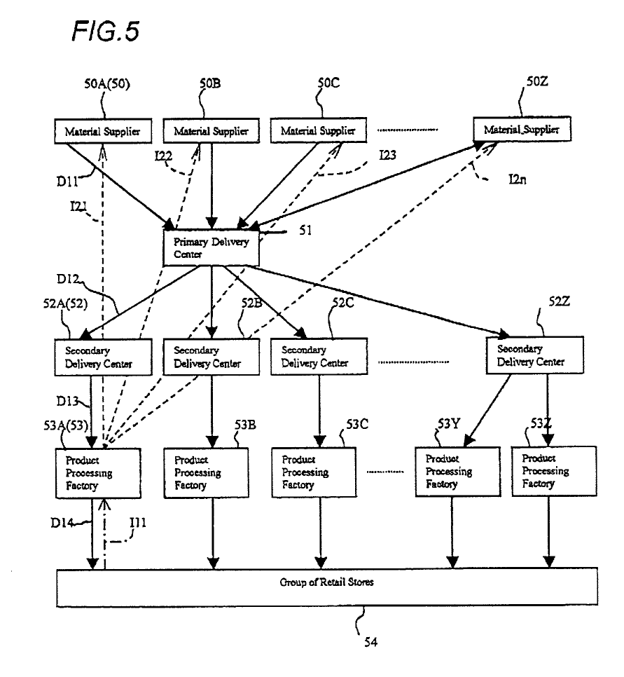

### DESCRIPTION OF THE PREFERRED EMBODIMENTS

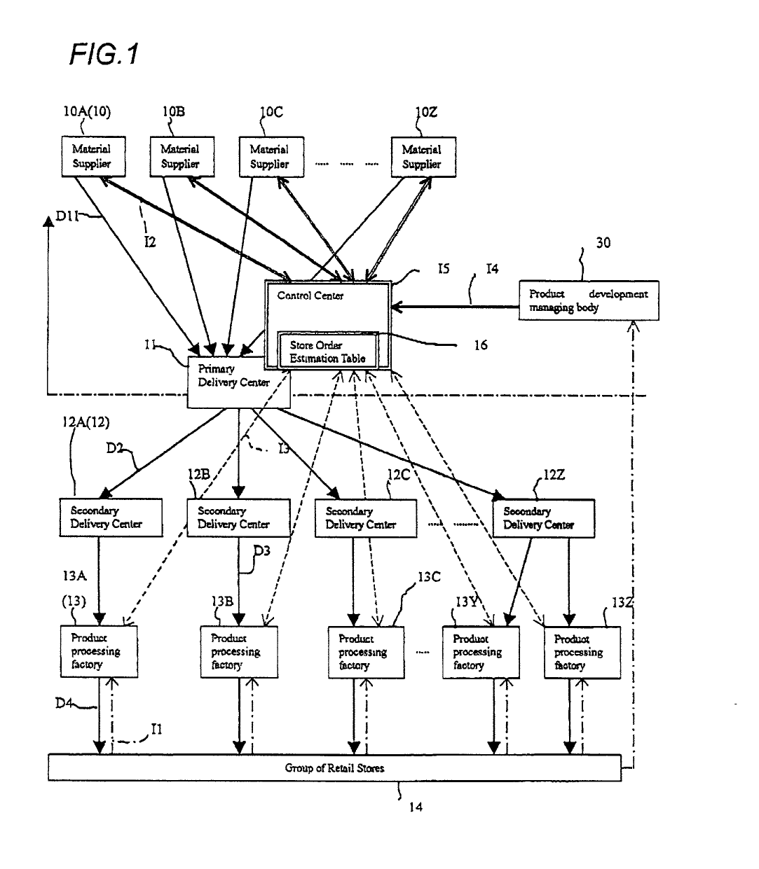

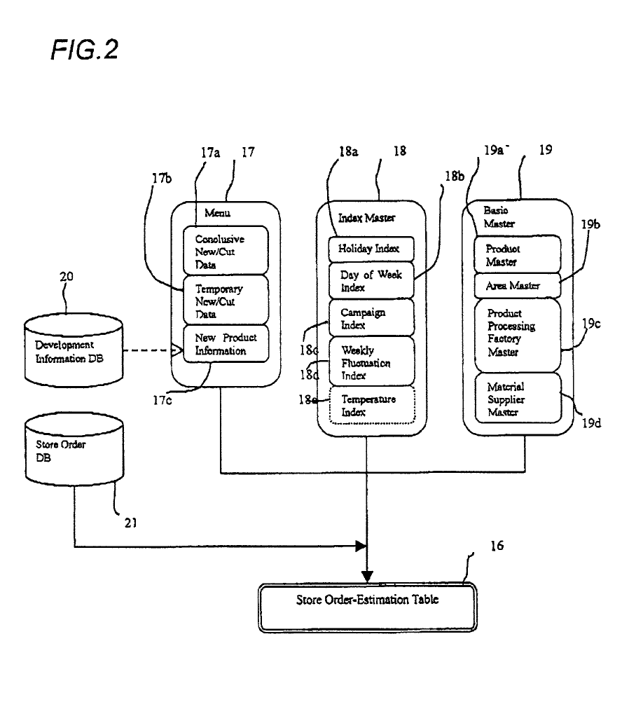

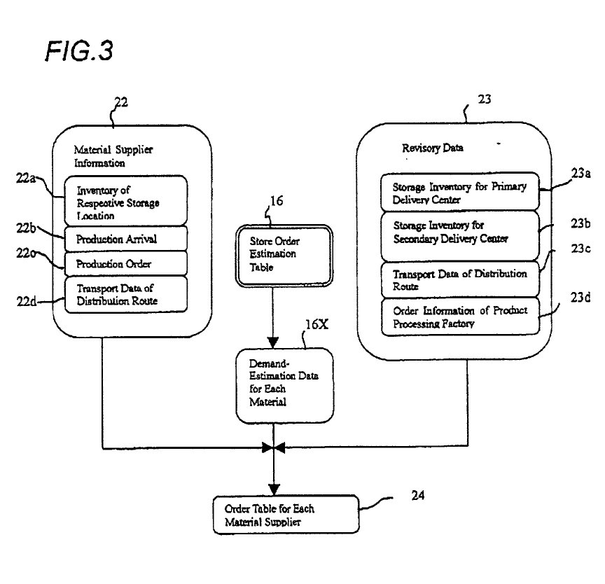

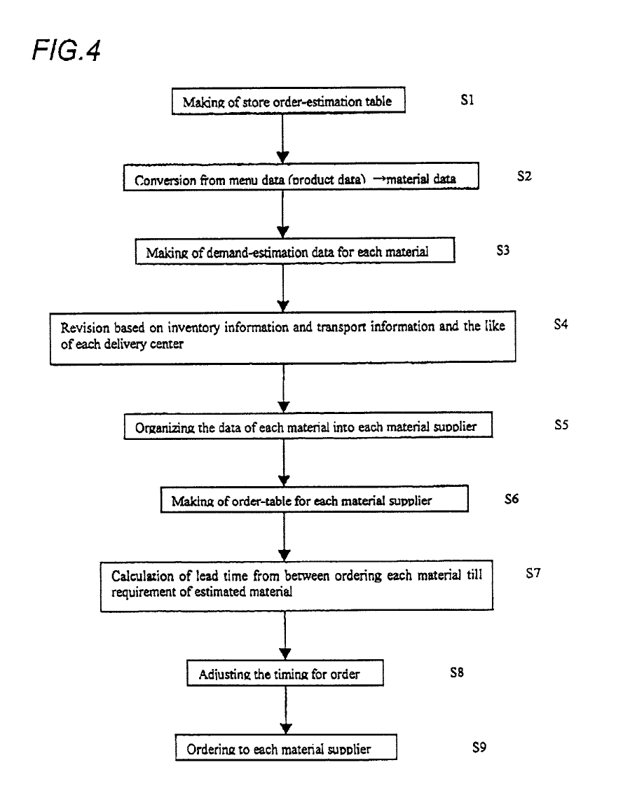

An embodiment of this invention will be described with reference to FIG. 1 and FIG. 3. FIG. 1 is a structural view showing a distribution management system regarding an embodiment of this invention; FIG. 2 is an explanatory view of making a store order-estimation table; FIG. 3 is an explanatory view of making a material order-estimation table by using a store order-estimation table; FIG. 4 is a flow chart of a control center starting from estimating a store order till ordering of materials.

A distribution management system regarding material used for lunches of convenience stores will be given as an example for describing this embodiment. Although, the distribution management system is comprised of a distribution route for handling the actual delivery of material and an information route for managing distribution including demand and order from an information aspect, the distribution route will be described first (see solid line arrow in drawing).

As shown in FIG. 1, located upstream of the distribution are plural material suppliers 10A . . . 10Z serving to provide respective material for lunches and sandwiches (e.g. trays, seasoning packs, knives-forks, chopsticks, food ingredient). The respective material is sent from the material suppliers 10 to a single primary delivery center 11 (distribution route D1).

The primary delivery center 11 is supplied with the respective material in a lump from the material suppliers 10, wherein the supplied material is divided and properly arranged into cargo destined to be supplied to each product processing factory 13A . . . 13Z. The divided cargo is sent to the secondary delivery centers 12A . . . 12Z (distribution route D2).

While calculating the appropriate timing (e.g. opening hours of the respective product processing factories 13A . . . 13Z), the respective secondary delivery centers 12A . . . 12Z delivers the respective material (distribution route D3). The product processing factory 53 serves to produce prescribed lunches and sandwiches by using the respective material and serves to supply the products to a group of retail stores 14 (distribution route D4).

Next, the information route of the above distribution management system will be described.

In respect of the distribution management system of this embodiment, a control center 15 is arranged within the primary delivery center 11. The control center 15 cooperates with a product development management body 30 (information route I4), wherein the product development managing body 30 serves to plan and develop outside section products and serves to manage order status or the like. Based on the information managed by the product development managing body 30 (described afterwards), the control center 15 makes a store order-estimation table 16 for estimating how many lunches are going to be ordered from a group of retail stores 14 to the respective product processing factories 13, and orders supply and instructs production to the material supplier 10 regarding the respective material at each predetermined period, e.g. each week, (information route 12).

The relation between the control center 15 and the material supplier 10 works in both directions, wherein an inventory data, a production status (unfinished) data and a pre-production data regarding the material supplier 10 are gathered so that the progress based on pre-instructed matters could be managed and confirmed. Including a material in the middle of being produced, a total inventory from the material supplier 10 till the product processing factory 13 of distribution route D3 could be compression controlled or adequately controlled by referring to the data of the store order-estimation table 16.

Accordingly, while a precisely detailed information route is built between the control center 15 and the material supplier 10, an information route between the control center 15 and the product processing factory 13 is also built for purposes such as voluntarily receiving an order from an product processing factory 13.

Accordingly, including an inventory status information of the primary delivery center 11 and the secondary delivery center 12, a material transport information of distribution route D1 . . . D3 is unitarily controlled by the control center 15 within the primary delivery center 11 in a real-time manner. That is, in relation between the material supplier 10, the control center 15 receives a supply of material by ordering a necessary quantity of necessary material with consideration of a demand estimate and inventory information (pulling type). In relation between the product processing factory 13, the control center 15 directly supplements the respective material considered to be required in an necessary quantity or prepares inventory at the secondary delivery center 12 by estimating an supply order from the product processing factory 13 (pushing type).

This distribution management system does not require the conventional style of waiting for order information sent from the retail store 14 in a bottom-up manner owing to the control center 15 serving as a driving force for motivating the distribution cycle.

Next, a making of a store order-estimation table will be described with reference to FIG. 2. The store order-estimation table 16 is data serving as a standard regarding a material supplying quantity for each product processing factory 13 and also a standard regarding a material ordering quantity for each material supplier 10.

As shown in FIG. 2, a menu data 17 having calculated a sales estimation value based on a past sales record serves as a base for the store order-estimation quantity in which the menu data 17 is calculated for each kind of lunch planned and developed by the product development managing body 30. Since the headquarters alters the kind of lunches and sandwiches depending on the season or on a campaign, the menu data 17 includes: a conclusive new/cut data 17a for adding data of a newly starting sales of a lunch or for omitting data of a lunch or sandwich having been discontinued for sales; a temporary new/cut data 17b for experimentally making alterations; and new product information 17c for adding information of a newly developed new product.

For example, while having an unchanging all-year basic menu as a base, the menu data 17 is renewed in a manner where a “chicken sandwich” is seasonally changed to a “turkey sandwich”, and further adding a “bagel sandwich” developed by the headquarters as a campaign product.

Since the sales of lunches and the like are affected by many daily factors, the basic menu data is revised by using an index master data 18. The index master 18 is comprised of, for example, a holiday index 18a for considering the difference of a holiday and a workday; a day of week index 18b for considering the sales effect depending on the day of the week; a campaign index 18c for considering the effect of a televised commercial campaign or the like being promoted by the headquarters; a weekly fluctuation index 18d for considering a fluctuation per-week; and a temperature index 18e for considering natural factors such as the weather and the climate or the like.

For example, the estimated index during the holidays is reduced in terms of a store located in an office part of town, or the estimated index of a particular lunch sandwich being promoted by a televised commercial campaign is increased, and then, a basic data is revised by multiplying the index to the basic data.

Subsequently, in means to output the store order-estimation table 16 for estimating when and what product is necessary, the above extracted data is applied to a basic master 19 including a product master 19a serving to list a menu of products, an area master 19b used for portioning out when selecting a distribution route or the like, a product processing factory master 19c, and a material supplier master 19d.

In this embodiment, the new product information 17c is created with reference to development information DB20, and the store order-estimation table 16 is revised with reference to a store order DB 21 recorded with an order status obtained in real-time from each retail store by using a POS system. The development information DB20 and the store order DB 21 is possess by the product development managing body 30. The store order DB 21 is obtained from information of the actual sales results of the group of retail stores 14 gathered by the product development managing body 30.

A method of making an order table for each material supplier will be explained by using FIG. 3. Based on an estimated order quantity of the store order-estimation table 16, a demand-estimation data for each material 16X, which is extracted by analyzing the necessary material for producing the various lunches, serves as a base data for an order table 24 regarding each material supplier 24. The data calculated by the store order-estimation table 16 is menu data meant for indicating the quantity and kind of lunch required for order, and the data itself could not be used as order data for the material suppliers 10. In other words, the menu data is required to be processed into material data for indicating the quantity and kind of material, and further, the material data is required to be organized into the respective material suppliers 10.

For example, when the menu data of the store order-estimation table 16 has a content having 800 estimated orders for lunch type A, 600 estimated orders for lunch type B, and 500 estimated orders for lunch type C, the content of the demand-estimation data for each material 16X would be 800 sets, 600 sets, 500 sets of “food ingredient type A”, “food ingredient type B”, “food ingredient type C”, respectively; however, when all of the types require the material “knife fork”, 1900 sets would be required, and when a seasoning pack (e.g. black pepper) is required for both “food ingredient for type B” and “food ingredient for type C”, 1100 packs of material “black pepper” would be required.

In a case where the estimated order for “bucket sandwich type D” is 800 sandwiches, and where the estimated order for “bucket sandwich type E” is 700 sandwich, and where the estimated order for “bagel sandwich type F” is 500 sandwiches, and where the estimated order for “bagel sandwich type C” is 400 sandwiches, the demand-estimation data for each material 16X would require: 1500 sets of material “long package used for bucket” when the same material is used for type D and type E; 900 sets of material “square package used for bagels” when the same material is used for type F and type G; and 2400 napkins used for all of the menus.

In a case where there are hundreds of menus of products and where for example “the day of starting the products” or “the day of ending the products” for the products are respectively different, the control center 15 serves to perform the above complicated sorting procedure. Accordingly, especially in terms of a lunch of a convenience store being highly standardized under a united brand, and further in terms of a field where concentration and unification of containers is required for cost reduction, concentrating the procedure of processing the menu data into material data at the control center 15 would benefit the product processing factory 13 and the material supplier 11 since operation would be exceedingly rationalized.

The extracted demand estimation for each material is processed by combining a material supplier information 22 including an inventory data for respective storage location 22a, a production arrival data 22b, a production instruction data 22c, and a transport data 22d for indicating the quantity of material existing on the distribution route D1, with a revisory data for the distribution route 23 including an inventory data for the primary delivery center 23a, an inventory data for the secondary delivery center 23b, a transport data 23c for indicating the quantity of material existing on the distribution route D2, D3, and order information of the product processing factory 23d; subsequently, an order table 24 for each material supplier is made for indicating the quantity, the kind of material and the material supplier required for order. The information of the order table 24 is notified to each material supplier 10 through an information route 12.

Next, by using the flow chart of FIG. 4, the process ending at the ordering of material by the control center 15 will be explained in time series. The information management is performed in a lump by a software for performing the above operations.

As shown in FIG. 4, based on a prescribed information, a store order-estimation table specifying an estimated order quantity and an estimated ordering time is made (S1), Based on a past sales results for each menu (product), the store order-estimation table is added with the new cut data, and is revised by adding the holiday index, the day of week index, the campaign index and the like so that the store order quantity of a product required to be produced by each product processing factory and the timing of the store order could be estimated.

The menu (product) data on the store order-estimation table is converted into information regarding the material required for producing the menu (S2). This conversion is performed by organizing on the basis of the constituting information of each menu provided by the product development managing body 30. The converted material data base information is then reorganized into demand-estimation data categorized into each material (S3).

The demand-estimation data is revised with consideration of the reserve production inventory including the already ordered inventory (in other words, the inventory already instructed for production) and the already produced inventory, and also with consideration of the total inventory including the information of the inventory for each delivery center existing on the distribution route and the transport inventory information regarding the inventory being in the midst of being transported and existing on the distribution route; accordingly, the precise genuinely required quantity of the order supply could be obtained (S4). Each of the materials are sorted into the respective material suppliers (e.g. ordering the materials a, b, d to a material supplier 10A while ordering the materials c, e to another material supplier 10B) (S5); then, the order table is made for the respective material suppliers (S6).

Further, the lead time between the time from when each material is ordered to the respective material suppliers till the time when each product processing factory orders a supply estimate to the secondary delivery center is calculated (S7); based on such information, the timing for ordering to the material suppliers is adjusted (S8). The supply estimate order time of each product processing factory to the secondary delivery center is separately calculated on the basis of estimate order time data within the store order-estimation table. When reaching a prescribed date, the material is actually ordered to the material supplier (S9).

Instead of adjusting the order timing to the material supplier, the timing of the arrival of the material to the secondary delivery center could adjusted by having the material supplier adjust the timing of the production of each material; however, for example, in a case where there had been an sudden change in the menu, it is favorable for the control center to make adjustments of timing since emergency stops may occur for the already ordered material.

Accordingly, the distribution management information having the control center 15 serve as a center is used as order information by the material supplier 10 and is also used as supply information, subsequently, based on such information the distribution route is operated.

The information being exchanged between the information route I1 to the information route I4 is gathered and managed at the control center by using the Internet or an exclusive line. The frequency of the exchange of information could be perform at all times and in real-time or could be performed on a daily basis.

Consequently, as explained above, the distribution management system of this embodiment is able to achieve unitary management of material since the actual management of material is concentrated toward the control center 15 in which the control center 15 takes initiative in ordering (pull) and supplying (push) the material via the primary delivery center 11 and the secondary delivery center 12. In respect of this distribution management system, the lead time between order and supply is shorter than that of the conventional bottom-up type distribution management system basically being controlled by the order information of the group of retail stores 14; further, this system exceedingly adaptable to changes such as change of product or change in store order-estimation quantity.

More particularly, a prescribed material of a sufficient quantity can be supplied at a suitable timing to the product processing factory 13 since the control center 15 is capable of performing a series of estimating the necessary quantity, supplying material, managing inventory, managing information, managing information, and disclosing the support requiring quantity, and is capable of overlooking the entire distribution and performing precise unitary management of material.

The control center 15 possesses information of reserve production inventory having already been ordered for supply to the material supplier 10 (in other words, reserve production inventory having already been instructed for production or inventory having already been produced); further, information of transport inventory existing on the distribution route is concentrated to the control center 15 on a daily basis through an online means. Accordingly, not only in the aspect of distribution but also in the aspect of time, the control center 15 is capable of unitarily managing the total inventory information from the respective material suppliers 10 to the respective product processing factories 13 including the production plan of the respective material suppliers 10. Therefore, the control center 15 is capable of compressing the inventory to a minimal quantity while preventing a shortage of a particular material.

Further, in respect of the supply order to the material supplier 10, the control center 15 can swiftly adapt to a case where a revision information likely to affect the store order-estimation table is applied (e.g. a sudden stop, change or addition in the product menu) since the control center 15 of this embodiment is directly or indirectly connected to the product development managing body 30.

Further, in terms of the respective product processing factories 13, the labor and the equipment investment conventionally required for the procedure of ordering material can be reduced and would result to cost reduction.

Although the control center 15 of this embodiment is positioned within the primary delivery center 11 for serving as both a control center and a primary delivery center, the control center 15 could be positioned independently; further, the control center 15 could also be positioned within the convenience store headquarters being the product development managing body.

Although the delivery center for this embodiment is comprised of a single central primary delivery center 11 and a plurality of district secondary delivery centers for receiving a supply from the primary delivery center 11, the primary delivery center 11 could be of plural numbers arranged for each district or the primary delivery center 11 could directly transport material to a portion of the product processing factories 13 without requiring an intermediary secondary delivery center 12. Further, in a case of a small-scale system, the primary delivery center 11 could directly deliver the material to a plurality of product processing factories 13 without requiring the secondary delivery center 12.

Although the embodiment above is explained using a distribution of food material for lunches or the like, this invention could be practiced upon distribution of a product being produced by a combination of materials such as automobiles, clothing or the like.

Compared to the conventional distribution management system and the conventional distribution management method being subordinate to the order information from the group of retail stores, the distribution management system and the distribution management method of this invention allows the control center or the delivery center positioned between each material supplier and each product processing factory to unitarily take initiative for ordering supply of material to the material supplier and for supplying material to the product processing factory.

Accordingly, the control center serving as a center controls the serial flow of the distribution system starting from the ordering a supply of material to the material supplier to the delivery of material to the product processing factory. Therefore, a sufficient quantity of material required for producing a product could be ordered and supplied without any shortage, and a creation of excessive dead stock or shortage can be prevented so that the distribution cost could be reduced.

Further, distribution could be managed more precisely by considering the transport inventory existing on the distribution route and by considering the lead time from the time of the supply order of each material till the time of supply, Accordingly, the distribution management system and the distribution management method of this invention enables the minimization of the inventory existing on the distribution route so that distribution could be performed efficiently without any waste.

The foregoing description of a preferred embodiment of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined by the claims set forth below.

What is claimed is:

1. A distribution management system comprising:
a plurality of material suppliers;
a plurality of product processing factories for processing a product by using material provided from the material suppliers;
a delivery center for combining and transporting plural various materials transported from the plural material suppliers with material of a quantity required by the product processing factories to the product processing factories; and
a control center for
making a store order-estimation table so as to make an estimation regarding a quantity of a product to be ordered from a store and a quantity required to be produced by the respective product processing factories based on a prescribed information,
deciding a quantity of the respective materials to be ordered to the material supplier based on the store order-estimation table and ordering the quantity to the material suppliers, and
deciding a quantity of the respective materials to be supplied to the product processing factories and instructing the delivery center to deliver the materials to the respective product processing factories.

2. The distribution management system according to claim 1, wherein the delivery center is comprised of a single or plural primary delivery center(s) for gathering respective materials from the material supplier, and a plurality of secondary delivery centers for receiving material sent from the primary delivery center(s) and further transporting the material to the product processing factories assigned to the plural secondary delivery centers.

3. The distribution management system according to claim 2, wherein the primary delivery center also serves as the control center.

4. The distribution management system according to claim 3, wherein the primary delivery center grasps a total inventory including: reserve production inventory having already been ordered for supply to the material supplier and reserve production inventory having already been produced at the material supplier, and transport inventory existing on a distribution route between the material supplier and the product processing factory;
wherein the primary delivery center compresses surplus inventory; and
wherein the primary delivery center adjusts an order quantity for the material supplier and a supply quantity for the product processing factory for enabling supply without any shortage.

5. The distribution management system according to claim 3, wherein the primary delivery center controls an ordering for each material by grasping a timing schedule regarding the material required from the product processing factory, and by considering a lead time starting from a time when each material is ordered to the material supplier to a time when the product processing factory orders an estimation to the delivery center.

6. A distribution management method comprising the steps of:
making a store order-estimation table to make an estimation regarding a quantity of a product to be ordered from the store and a quantity required to be produced by the respective product processing factories based on a prescribed information;
making a demand estimation data for each respective material by converting product based data into material based data based on the store order-estimation table;
making an order table organized into each material supplier by considering and revising the demand estimation data for at least the inventory of the respective delivery centers; and
ordering to each material supplier based on the order table.

7. The distribution management method according to claim 6, wherein the revision of the demand estimation data is performed with consideration of transport inventory existing on a distribution route for each material.

8. The distribution management method according to claim 6, wherein the ordering to each of the material suppliers is performed with consideration of a lead time starting from a time when each material is ordered to the material supplier to a time when the product processing factory orders an estimation to the delivery center.

9. The distribution management method according to claim 6, wherein the ordering to each of the material suppliers is performed with consideration of inventory information of each material supplier and production plan information.
